(19) United States
(12) Patent Application Publication
(10) Pub. No.: US 2007/0269764 A1
(43) Pub. Date: Nov. 22, 2007

(54) Orthodontic Appliance Attachment

(76) Inventor: Jedediah Feller, Las Vegas, NV (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 11/739,483

(22) Filed: Apr. 24, 2007

Related U.S. Application Data
(62) Division of application No. 11/120,823, filed on May 3, 2005.
(60) Provisional application No. 60/573,704, filed on May 21, 2004.

(51) Int. Cl. A61C 7/26

(52) U.S. Cl. 433/22

(57) ABSTRACT

An attachment for orthodontic appliances, such as orthodontic braces, retainers, or other oral health devices, and a method of removably attaching the attachment to the orthodontic appliances, is disclosed.

### CROSS-REFERENCE TO RELATED APPLICATION

The present application claims the benefit of utility patent application Ser. No. 11/120,823 filed in the United States Patent and Trademark Office on May 3, 2005 and provisional application No. 60/573,704, filed in the United States Patent and Trademark Office on May 21, 2004.

### FEDERALLY SPONSORED RESEARCH OR DEVELOPMENT

Not Applicable.

### TECHNICAL FIELD

This invention generally relates to attachments to an orthodontic appliance, such as orthodontic braces, a retainer, or other oral health device, and, more particularly, to a method and apparatus enabling decorative, aesthetic and/or protective attachments for the bracket or wire of the orthodontic appliance.

### BACKGROUND OF THE INVENTION

Individuals exert significant efforts and use various means to hide or minimize the apparent unsightliness of the orthodontic appliance and/or differentiate, visually enhance and display the orthodontic appliance in a personalized manner. Indeed certain apprehensions associated with wearing the orthodontic appliance, particularly by children and young adults, may be minimized when orthodontists and other oral health professionals use colors, designs, or other features to distinguish and personalize the orthodontic appliance. Existing options for differentiation include colored elastomeric ties, objects affixed to orthodontic braces using intertwining wires, or colored orthodontic appliance material. However the existing options often require the oral health professional's assistance in order to modify the distinguishing feature and in some instances (e.g., colored orthodontic appliance material), the distinguishing feature cannot be modified without substantial expense.

Patients, especially children and young adults, often change such patients' preferences over the months, if not years, that the patients need to wear the orthodontic appliance. Therefore, it would be preferable to have a low cost apparatus that can allow the patients more freedom in the choices of differentiating and personalizing the patients' orthodontic appliances.

The present invention is provided to address these and other issues.

### BRIEF DESCRIPTION OF THE DRAWINGS

FIGS. 1a, 1b and 1c are drawings of respective side, front (i.e., view looking into the mouth of a patient) and rear views of a first version of a first embodiment of the apparatus in the shape of a donut.

FIG. 1d is a drawing of another front view of the first version of the first embodiment of the apparatus as illustrated with orthodontic braces on a pair of teeth.

FIGS. 2a, 2b and 2c are drawings of respective side, front and rear views of a second version of the first embodiment of the apparatus in a cylindrical or elongate shape.

FIGS. 2d, 2e and 2f are drawings of side, front and rear views of a third version of the first embodiment of the apparatus in an elongate shape and a slit, gap or other entry with a stop to receive and secure the wire in the lumen.

FIGS. 3a, 3b, 3c, 3d and 3e are drawings of side, front, rear, side and rear views of a fourth version of the first embodiment of the apparatus in the shape of two or more donuts, each donut having the entry to receive the wire, connected by an outer surface.

FIGS. 4a, 4b, 4c and 4d are drawings of side, front, rear and front (illustrated with teeth) views of a first version of a second embodiment of the apparatus having a hook to attach directly to a bracket.

FIGS. 5a, 5b, 5c and 5d are drawings of side, front, rear and front views of a second version of the second embodiment of the apparatus having a bar to attach directly to the bracket.

FIGS. 6a, 6b, 6c, 6d, 6e and 6f are drawings of side, front, side, front, and two top views of a third version of the second embodiment of the apparatus having an engaging opening to attach directly to the bracket.

### DETAILED DESCRIPTION OF THE INVENTION

While this invention is susceptible of embodiment in many different forms, there is shown in the drawings, and will be described herein in detail, specific embodiments thereof with the understanding that the present disclosure is to be considered as an exemplification of the principles of the invention and is not intended to limit the invention to the specific embodiments illustrated.

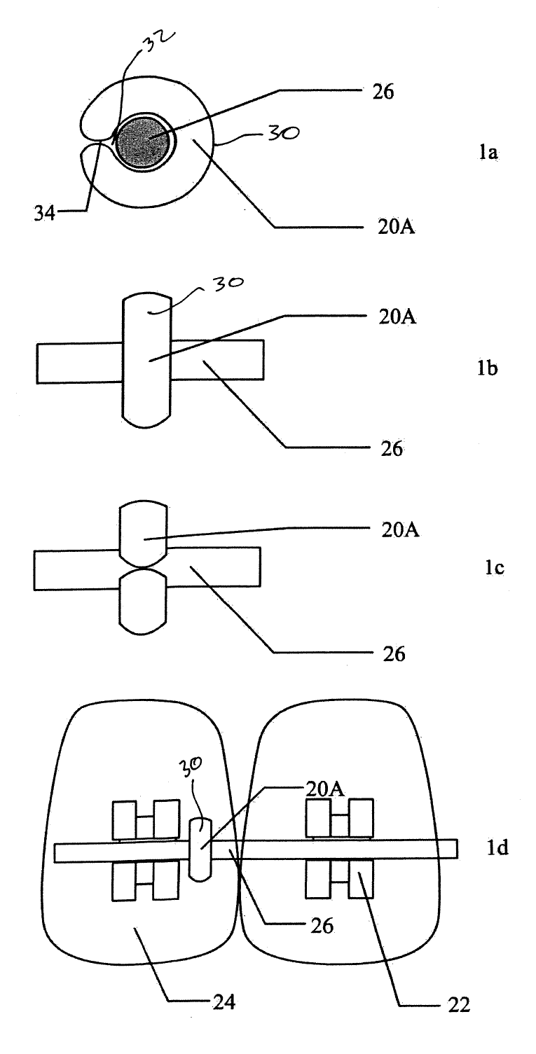

Referring to FIG. 1d, orthodontic braces typically include a plurality of brackets 22 attached to a patient's teeth 24 interconnected by a wire 26. Other orthodontic appliances include some or all of the elements identified in the orthodontic braces. For example, retainers have the wire 26.

The invention, as illustrated herein in various embodiments, is an apparatus 20 that can be attached to, and a method enabling the apparatus 20 to attach to, orthodontic braces or other orthodontic appliances.

The apparatus 20 can be made using plastic or other inexpensive flexible material. The apparatus 20 can be made with, or be susceptible to embody, one or more shapes, heights, lengths, colors, designs, letters, numbers, pictures, drawings, trademarks, logos, and/or other distinguishing or differentiating features. For example, the patient could spell a word or name, depict a jersey number or graduation year, or depict the patient's favorite or school colors. One of the differentiating features includes a circular, square, rectangular, or other shaped opening or window 28 allowing a front view of all or a portion of the plurality of the brackets 22 and/or the wire 26. An oral health professional may give the patient a packet containing a sufficient number of one or more varying embodiments of the apparatus 20 with differentiating features. The apparatus 20 can then be applied, sometimes without the oral professional's assistance, with a reasonable amount of pressure and easily changed, mixed, matched and replaced with one or more apparatuses 20 with a different differentiating feature depending upon the patient's preference.

First and second versions of a first embodiment of the apparatus 20A are illustrated in FIGS. 1a-d and 2a-2c, respectively. The first version of the first embodiment includes an outer surface 30, a lumen 32, and a slit, gap or other entry 34 extending between the outer surface 30 and the lumen 32. The entry 34 receives the wire 26 into the lumen 32 for retaining the apparatus 20 on the wire 26. The entry 34 may be formed by overlapping, inter-locked, laterally positioned, parallel positioned, or other positioned ends.

In FIGS. 1a, 1b, and 1c, side, front (i.e., viewing looking into the mouth of the patient) and rear views, respectively, of the first version of the first embodiment of the apparatus 20A are illustrated in the shape of a donut. The apparatus 20A has the entry 34 to allow the apparatus 20A to attach directly to the wire 26 by slipping the apparatus 20A over the wire 26 and receiving the wire 26 into the lumen 32 so that the apparatus 20A rests on the wire 26. This shape of the embodiment of the apparatus 20A is primarily decorative and allows the patient to attach one or more apparatuses 20A, each or all of the apparatuses 20A having one or more differentiating features. In FIG. 1d, another front view of the first embodiment of the apparatus 20A is illustrated in reference to the teeth 24, the bracket 22 and the wire 26.

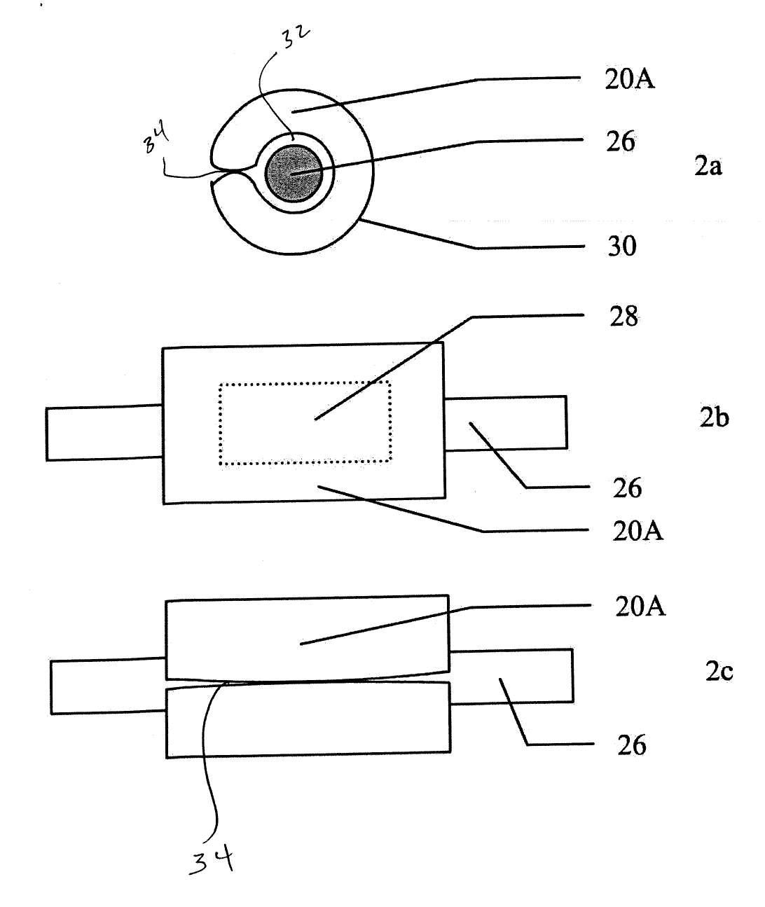

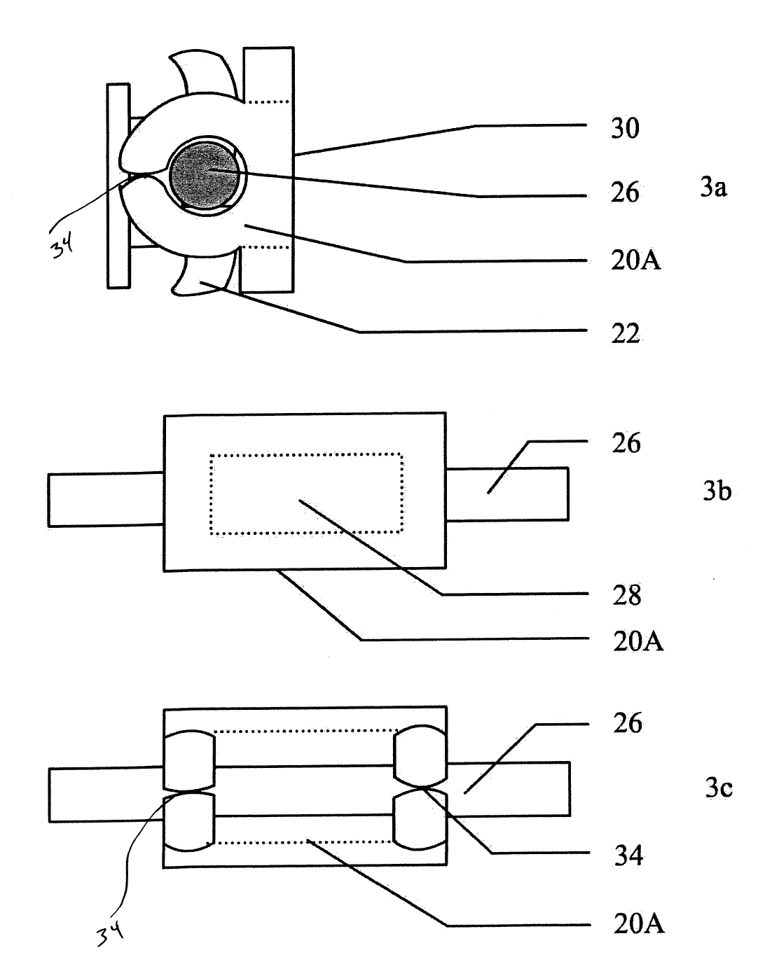

In FIGS. 2a, 2b and 2c, side, front and rear views, respectively, of the second version of the first embodiment of the apparatus 20A are illustrated in the shape of a cylindrical or elongate shape with an optional window 28 illustrated in phantom. This embodiment of the apparatus 20A is similar to the illustrations identified in FIGS. 1a-1d, but provides a greater outer surface 30 to cover more wire 26 and allow more options with respect to distinguishing features.

In FIGS. 2d, 2e and 2f, side, front and rear views, respectively, of a third version of the first embodiment of the apparatus 20A are illustrated with the entry 34 dimensioned in a wider manner compared to the entry 34 illustrated in FIGS. 2a-2c. This version includes a stop 35 dimensioned to secure the wire 26 in the lumen 32.

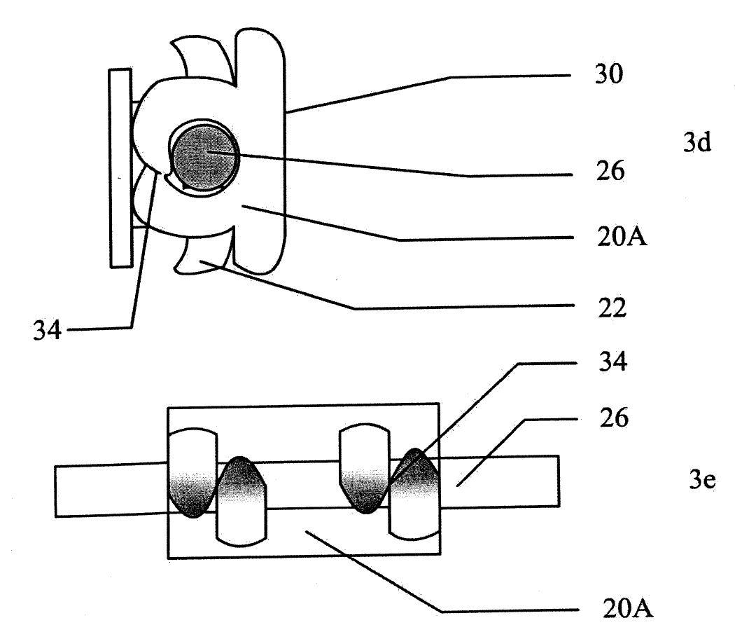

In FIGS. 3a, 3b and 3c, side, front and rear views, respectively, of a fourth version of the first embodiment of the apparatus 20A are illustrated in the shape of two or more connected donuts with the entry 34 on each donut to allow the apparatus 20A to attach directly to the wire 26. Similar to the views illustrated in FIGS. 1a-2c, the entry 34 allows the apparatus 20A to attach directly to the wire 26 by slipping the apparatus 20A over the wire 26, receiving the wire 26 into the lumen 32 and resting the apparatus 20 on the wire 26. The apparatus 20A may be placed between a plurality of brackets 22 to cover more wire 26. The apparatus 20A may also be placed on each side of one or more brackets 22 to cover one or more brackets 22. The connecting outer surface 30 allows for more options with respect to distinguishing features. For example the dotted lines of FIGS. 3a and 3c show optional height variations of the outer surface 30 and FIG. 3b shows an optional window 28.

In FIGS. 3d and 3e, side and rear views, respectively, of a fifth version of the first embodiment of the apparatus 20A show a variation wherein the entry 34 is formed by overlapping ends of the apparatus 20A, allowing the apparatus 20A to attach directly to the wire 26 in a more secure manner.

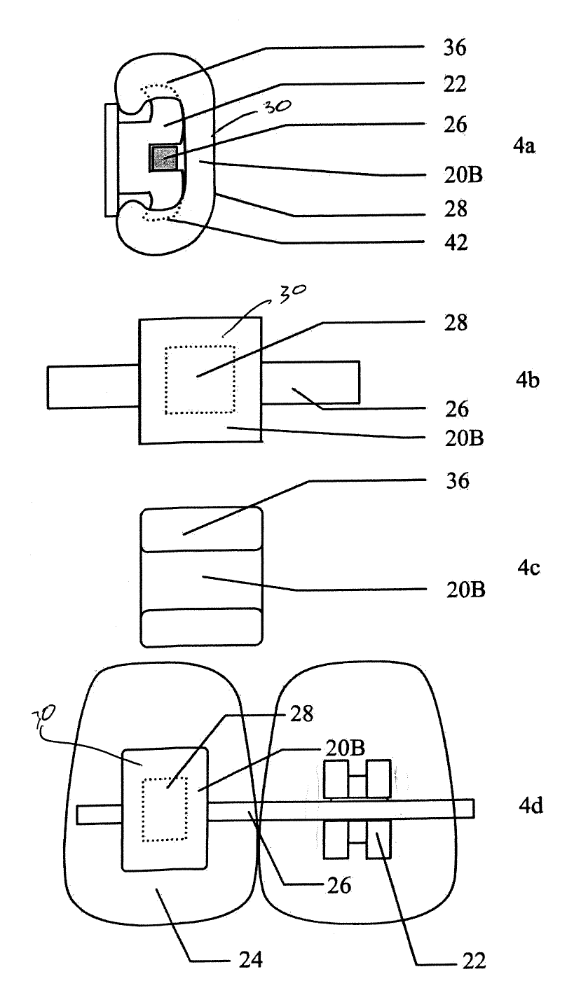

Three versions of a second embodiment of the apparatus 20B are illustrated in FIGS. 4a-4d, 5a-5d and 6a-6e, respectively. Each of the three versions of the second embodiment of the apparatus 20B includes the outer surface 30 and an upper and lower engaging member, such as a hook 36 in a first version, a bar 38 in a second version and an engaging opening 40 in a third version. The upper and lower engaging member engages and secures the apparatus 20B to the upper and lower portion of the bracket 22. This second embodiment of the apparatus 20B enables attachment directly to the bracket 22 in a manner that would not cause interference with the wire 26.

In FIGS. 4a, 4b, and 4c, side, front and rear views of the first version of the second embodiment of the apparatus 20B are illustrated in the shape of a backward letter C, the upper hook 36 engaging above and behind a top portion of the bracket 22 and the lower hook 36 engaging below and behind the lower portion of the bracket 22. This embodiment of the apparatus 20B is much like a cap over the bracket 22 and is not intended to cause interference with the wire 26. The outer surface 30 will be the portion seen by others when the patient smiles and can be used to depict various differentiating features. Furthermore, the apparatus 20B may hide certain unaesthetic aspects of the bracket 22. FIG. 4a shows an optional block 42 on width ends of the apparatus 20B encapsulating the side width ends of the upper and lower portions of the bracket 22. The optional block 42 minimizes side-to-side movement of the apparatus 20B from the bracket 22. FIG. 4b shows an optional window 28. In FIG. 4d, another front view of the second embodiment of the apparatus 20B is illustrated in reference to the teeth 24, the bracket 22 and the wire 26, along with the optional window 28.

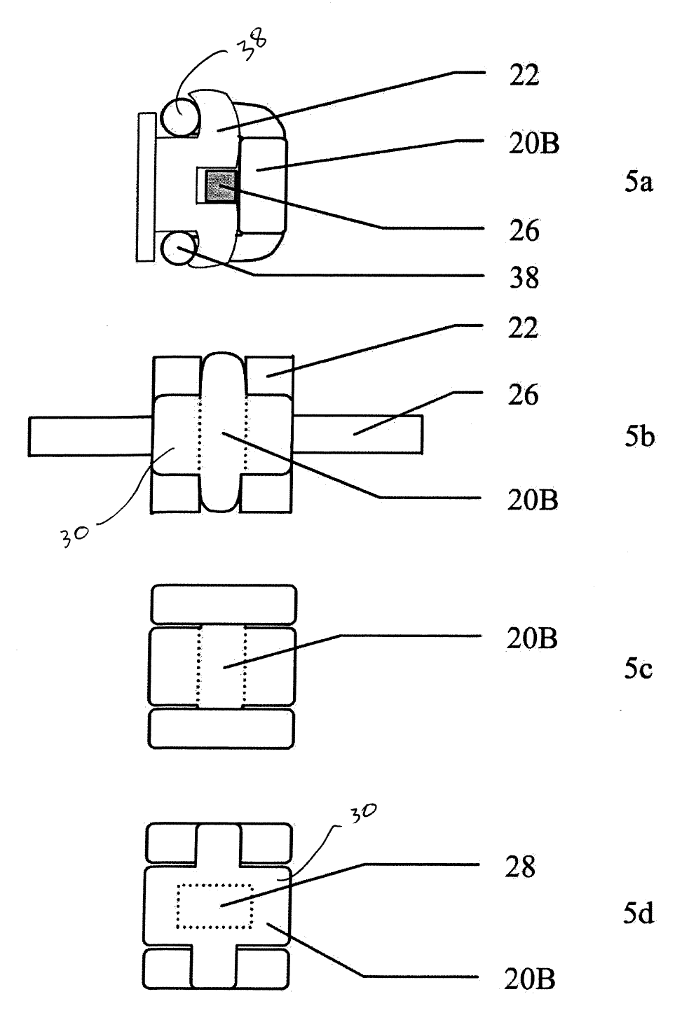

In FIGS. 5a, 5b, 5c and 5d, side, front, rear and other front views of the second version of the second embodiment of the apparatus 20B are illustrated in the shape of a backward letter C similar to the embodiment of the apparatus 20B illustrated in FIGS. 4a-4c. However this embodiment of the apparatus 20B includes a t-shaped top bar 38 for engaging between and behind the top portion of the bracket 22 and a t-shaped bottom bar 38 engaging between and behind the lower portion of the bracket 22. In these views, the top and bottom bars 38 fit securely behind the top and lower portion of the bracket 22. FIGS. 5b and 5c shows an optional larger width in the middle portion of the apparatus 20B, allowing a greater surface area. FIG. 5d shows an optional window 28.

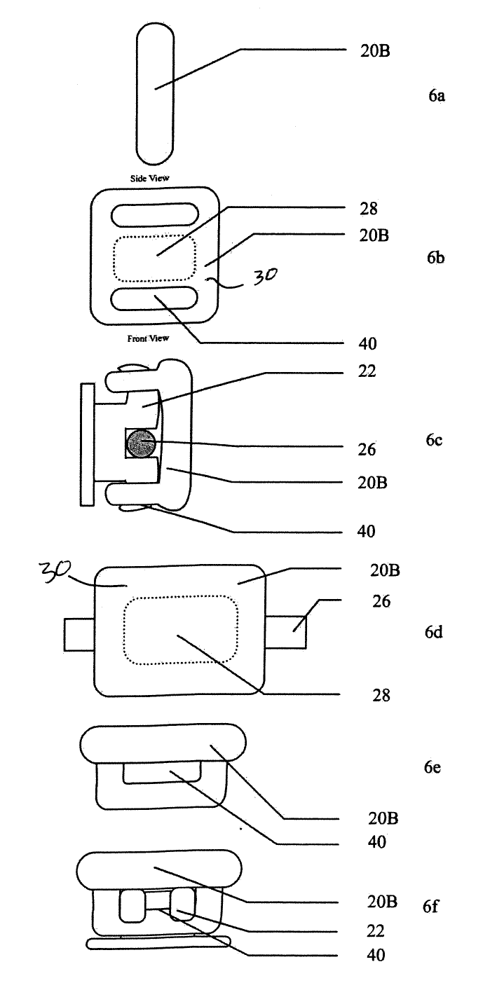

In FIGS. 6a, 6b, 6c, 6e, 6d, 6e and 6f, side, front, another side, another front, and two top views of the third version of the second embodiment of the apparatus 20B are illustrated which include an upper and lower engaging opening 40. When flexibly bent or stretched, the upper engaging opening 40 engages around and behind the upper portion of the bracket 22 by receiving the upper portion of the bracket 22, allowing the upper portion of the bracket 22 to fit securely in the engaging opening 40. Similarly, the engaging opening 40 engages around and behind the lower portion of the bracket 22 by receiving the lower portion of the bracket 22, allowing the lower portion of the bracket 22 to fit securely in the engaging opening 40.

FIGS. 6b and 6d show the optional window 28. FIGS. 6c, 6e and 6f show an optional taller outer surface to hide a greater portion of the bracket 22 and allow for a larger outer surface 30.

A third embodiment of the apparatus 20C includes the outer surface 30, one or more distinguishing features, such as the window 28, embodied on the outer surface 30 and a temporary glue or other adhesive 44 on the back side of the outer surface 30. The temporary adhesive attaches the apparatus 20C to the bracket 22, the second embodiment of the apparatus 20B, or another object attached to the bracket 22 or wire 26.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

What is claimed is:

1. For an orthodontic appliance having a wire, a decorative apparatus comprising:
an outer surface, a lumen and an entry extending between the outer surface and the lumen, the entry for receiving the wire into the lumen enabling attachment directly on the wire.

2. The apparatus of claim 1 wherein the outer surface contains a differentiating feature.

3. The apparatus of claim 2 wherein the differentiating feature includes a window in the outer surface.

4. The apparatus of claim 2 wherein the outer surface is a cylinder shape.

5. The apparatus of claim 1 wherein the outer surface is elongated.

6. The apparatus of claim 1 wherein the outer surface connects a first lumen having a first entry and a second lumen having a second entry.

7. The apparatus of claim 1 wherein the entry is between one of overlapping, inter-locked, laterally positioned, or parallel-positioned ends of the outer surface.

8. The apparatus of claim 7 wherein the entry further comprises a stop.

9. A method for attaching an apparatus to an orthodontic appliance, the orthodontic appliance having a wire, the method comprising:
providing the apparatus comprising an outer surface, a lumen and an entry extending between the outer surface and the lumen; and
receiving the wire through the entry into the lumen enabling attachment of the apparatus directly to the wire.

10. The method of claim 9, the orthodontic appliance having a bracket, further comprising:
a first entry receiving the wire extending from a first side of the bracket; and
a second entry receiving the wire extending from a second side of the bracket.

11. The method of claim 9 further comprising embodying a differentiating feature to the outer surface.
